(19) United States
(12) Patent Application Publication
(10) Pub. No.: US 2009/0280405 A1
(43) Pub. Date: Nov. 12, 2009

(54) PROCESS FOR MODIFYING THE INTERFACIAL RESISTANCE OF A METALLIC LITHIUM ELECTRODE

(76) Inventors: Lucas Sannier, Calais (FR); Marek Marczewski, Warszawa (PL); Hanna Marczewska, Warszawa (PL); Aldona Zalewska, Kielpin (PL); Wladyslaw Wieczorek, Mysiadlo (PL)

Correspondence Address: CROWELL & MORING LLP;INTELLECTUAL PROPERTY GROUP, P.O. BOX 14300, WASHINGTON, DC, 20044-4300, US

(21) Appl. No.: 12/305,145

(22) PCT Filed: Jun. 8, 2007
(86) PCT No.: PCT/FR2007/000948

§ 371 Date: Dec. 16, 2008

(30) Foreign Application Priority Data
Jun. 16, 2006 (FR) 0605399

(51) Int. Cl. H01M 10/26; H01M 4/02; H01M 4/58

(52) U.S. Cl. 429/207; 205/57; 429/231.95

(57) ABSTRACT

The invention relates to a method of modifying the interfacial resistance of a lithium metal electrode immersed in an electrolytic solution, which consists in depositing a film of metal oxide particles on the surface of this electrode.

The invention also relates to a lithium metal electrode, the surface of which is covered with a film of metal oxide particles, and to a battery of the lithium metal type.

The invention relates to a method of modifying the interfacial resistance of a lithium metal electrode, also to a lithium metal electrode and an Li-metal battery comprising such an electrode.

### BACKGROUND OF THE INVENTION

The use of lithium metal as a negative electrode for batteries was envisaged decades ago. This is because lithium metal has the advantage of having a high energy density because of its low density and because it is highly electropositive character. However, the use of lithium metal in a liquid medium leads to degradation of the electrolytic solution due to contact with the lithium, and also poses safety problems due to the formation of dendrites on the surface of the metal, which may lead to a short circuit causing the battery to explode.

To get round the problem of electrolytic solution degradation, several approaches have been envisaged.

One approach consists in replacing the lithium electrode with for example a graphite electrode (Li-ion batteries). However, this replacement is to the detriment of the specific capacity of the battery.

Another approach consists in replacing the liquid electrolytic solution with a solid polymer, which is less sensitive to degradation (batteries called “all-solid-state” batteries).

However, in this type of device, the battery can operate only at high temperatures, of around 80° C., thereby limiting the fields of application. Attempts to improve these “all-solid-state” systems have been made, by adding mineral fillers in POE (polyoxyethylene)-based electrolytes (F. Croce et al., Nature, vol. 394, 1998, 456-458, and L. Persi et al., Journal of the Electrochemical Society, 149(2), A212-A216, 2002). The purpose of adding mineral fillers is to reduce the crystallinity of the POE so as to improve the rate of transport of the Li⁺ ions. However, in such systems, the mineral fillers are blocked within the polymeric material forming the electrolyte, and consequently have only a little effect on the interfacial resistance of the lithium electrode, which is the key factor in determining the degradation of the electrolyte on the surface of the electrode. This is because, conventionally, the interfacial resistance progressively increases during the electrochemical process until a plateau is reached, and the addition of fillers into solid electrolytes merely has the effect of reducing the value of the interfacial resistance at the plateau.

In an attempt to reduce the interfacial resistance, document U.S. Pat. No. 5,503,946 proposes an anode for a lithium cell covered with a film consisting of carbon or magnesium particles. However, this system enables only a moderate reduction in the interfacial resistance to be achieved.

### SUMMARY OF THE INVENTION

The inventors have developed a method of modifying the interfacial resistance of a lithium electrode immersed in an electrolytic solution which, surprisingly, substantially limits the degradation of the electrolyte in contact with the lithium metal. As a consequence, this method makes it possible to envisage using lithium metal electrodes in liquid electrolytes, and therefore at ambient temperature, for the manufacture of high-performance batteries.

For this purpose, according to a first aspect, the invention provides a method of modifying the interfacial resistance of a lithium metal electrode immersed in an electrolytic solution, which consists in depositing a film of metal oxide particles on the surface of said electrode.

The film of particles deposited protects the surface of the lithium metal electrode, thereby resulting in a substantial reduction in the resistance of the interface between the lithium and the electrolyte.

### BRIEF DESCRIPTION OF THE DRAWINGS

FIG. 1a illustrates the ionic conductivity by the complex impedance method for the electrolytic solution containing a lithium salt concentration equal to 3 mol per kg of polymer. FIG. 1a shows the logarithm of the conductivity, expressed in siemens per centimeter (S·cm⁻¹), as a function of the inverse of the temperature (expressed in degrees kelvin) multiplied by a factor of 1000.

FIG. 1b illustrates the ionic conductivity by the complex impedance method for the electrolytic solution containing a lithium salt concentration equal to 1 mol per kg of polymer. FIG. 1b shows the logarithm of the conductivity, expressed in siemens per centimeter (S·cm⁻¹), as a function of the inverse of the temperature (expressed in degrees kelvin) multiplied by a factor of 1000.

FIG. 1c illustrates the ionic conductivity by the complex impedance method for the electrolytic solution containing a lithium salt concentration equal to 0.01 mol per kg of polymer. FIG. 1c shows the logarithm of the conductivity, expressed in siemens per centimeter (S·cm⁻¹), as a function of the inverse of the temperature (expressed in degrees kelvin) multiplied by a factor of 1000).

FIG. 2 shows the results of the DSC measurements of the electrolytic solutions. FIG. 2 shows the glass transition temperature T_{g}, expressed in degrees kelvin, as a function of the lithium salt concentration C, expressed in mol/kg.

FIG. 3 shows the results for the change in interfactial resistance of the four cells. The interfacial resistance Ri (in ohms·cm²) is plotted as a function of the square root of the time Rt, the time being expressed in days.

FIG. 4 shows the curves obtained from studying the stability of the electrolytic solution/lithium electrode interface by galvanostatic polarization with a current density j=0.3 mA/cm². In FIG. 4, the potential P in volts is plotted as a function of the time t in minutes.

### DETAILED DESCRIPTION OF THE PREFERRED EMBODIMENTS

According to a preferred embodiment of the invention, the particles are deposited by dispersing them in the electrolytic solution followed by their sedimentation on the surface of the electrode. Such a method of deposition has the advantage of being particularly simple since the formation of the film takes place by sedimentation over the course of time of the particles dispersed in the electrolytic solution.

The metal oxide constituting the particles is for example chosen from Al₂O₃, SiO₂, TiO₂, ZrO₂, BaTiO₃, MgO and LiAlO₂. These particles are readily available commercially and are of low cost.

Furthermore, prior to the deposition, the metal oxide particles may be modified by grafting onto their surface groups having an acidic character.

In particular, the metal oxide particles may be Al₂O₃ particles modified by SO₄²⁻ groups.

The metal oxide particles may be modified by bringing the particles into contact with an aqueous solution containing the acid groups to be grafted, followed by drying and calcination of the particles. This type of treatment, commonly used in catalytic chemistry, has the advantage of being simple to implement.

The electrolytic solution typically consists of a lithium salt and a solvent or a mixture of polar aprotic solvents. As examples, mention may be made of linear ethers and cyclic ethers, esters, nitrites, nitro derivatives, amides, sulfones, sulfolanes, alkylsulfamides and partially halogenated hydrocarbons. The particularly preferred solvents are diethyl ether, dimethyl ether, dimethoxyethane, glyme, tetrahydrofuran, dioxane, dimethyltetrahydrofuran, methyl or ethyl formate, propylene or ethylene carbonate, alkyl carbonates (especially dimethyl carbonate, diethyl carbonate and methyl propyl carbonate), butyrolactones, acetonitrile, benzonitrile, nitromethane, nitrobenzene, dimethylformamide, diethylformamide, N-methylpyrrolidone, dimethyl sulfone, tetramethylene sulfone, tetraalkylsulfonamides having from 5 to 10 carbon atoms, a low-mass polyethylene glycol. As one particular example, mention may be made of polyethylene glycol dimethyl ether.

The lithium salt of the electrolyte may be an Li⁺Y⁻ ionic compound in which Y⁻ represents an anion having a delocalized electronic charge, for example Br⁻, ClO₄⁻, PF₆⁻, AsF₆⁻, R_{F}SO₃⁻, (R_{F}SO₂)₂N⁻, (R_{F}SO₂)₃C⁻, C₆H₍₆₋ₓ₎(CO(CF₃SO₂)2C⁻)ₓ or C₆H₍₆₋ₓ₎(SO₂(CF₃SO₂)₂C⁻)ₓ, R_{F} representing a perfluoroalkyl or perfluoroaryl group, where 1≦x≦4. The preferred ionic compounds are lithium salts, and more particularly (CF₃SO₂)₂N⁻Li⁺, CF₃SO₃⁻Li⁺, the compounds C₆H₍₆₋ₓ₎⁻[CO(CF₃SO₂)₂C—Li⁺]ₓ in which x is between 1 and 4, preferably with x=1 or 2, the compounds C₆H₍₆₋ₓ₎—[SO₂(CF₃SO₂)₂C⁻Li⁺]ₓ in which x is between 1 and 4, preferably with x=1 or 2. Mixtures of these salts together or with other salts may be used.

According to one embodiment, the solvent of the electrolytic solution consists of polyethylene glycol dimethyl ether (PEGDME) and the lithium salt is lithium perchlorate (LiClO₄).

The metal oxide particles may be deposited on the surface of the electrode during the operation of an electrochemical cell comprising an anode, formed by said electrode, and a cathode, the anode and the cathode being separated by an electrolytic solution. If the electrochemical cell is used as a battery, the deposition may take place either before the battery is put into operation or during the first operating cycles of the battery. This is because, since the particles are preferably dispersed in the electrolytic solution, it is possible to allow them to sediment on the surface of the anode before the battery is operated, or else to operate the battery as soon as its arrangement has been completed, the sedimentation then taking place naturally during the first cycling operations.

According to a second aspect, a subject of the invention is a lithium metal electrode for a battery, the surface of said electrode being covered with a film of metal oxide particles.

In this electrode, the particles constituting the film are Al₂O₃ particles modified on the surface by SO₄²⁻ groups.

According to a third aspect, the invention provides a battery of the lithium metal type, comprising an anode and a cathode that are separated by an electrolytic solution, characterized in that:
the anode and the cathode are in the form of parallel sheets, the cathode being above the anode; and
the anode consists of a lithium sheet, the surface of which facing the electrolytic solution is covered with a film of metal oxide particles, said particles being as defined above.

Preferably, the sheets constituting the anode and the cathode are horizontal or approximately horizontal.

In a battery according to the invention, the cathode may comprise at least one transition metal oxide capable of reversibly inserting and extracting lithium, for example chosen from the group formed by LiCoO₂, LiNiO₂, LiMn₂O₄, LiV₃O₈, V₂O₅, V₆O₁₃, LiFePO₄ and LiₓMnO₂ (0<x<0.5), as well as an electronic conductor (such as carbon black) and a binder, of polymer type. The cathode generally also includes a current collector, for example made of aluminum.

The electrolytic solution consists of a lithium salt and a solvent or a mixture of solvents, the salt and the solvent being as defined above.

The present invention will be illustrated below by concrete exemplary embodiments, to which however the invention is not limited.

The method according to the invention was implemented with suspensions of Al₂O₃ particles surface-modified by the grafting of SO₄²⁻ groups in an LiClO₄ electrolytic solution in PEGDME. Different degrees of grafting were used for the various examples.

### Preparation of Al₂O₃/SO₄²⁻ Particles

The Al₂O₃ particles used were sold by the company ABCR Karlsruche. The particle size varied between 1.02 and 1.20 mm. The surface modification was carried out by implementing in succession the following steps:
impregnation of the particles with an aqueous H₂SO₄ solution;
drying of the particles in two successive steps, at 60° C. and 100° C. respectively for 24 hours; and then
calcination of the particles in a stream of dry air at a temperature of 500° C. for 24 hours.

The particles were then ground, for 4 hours at 300 revolutions/minute, and then screened so as to obtain a fine homogeneous powder, the average size of the particles being less than 10 μm.

This method of operation was followed using various aqueous H₂SO₄ solutions, the respective concentrations of which were calculated so as to obtain several types of particle, the degree of grafting of which is indicated in Table 1 below. Ungrafted Al₂O₃ particles were also prepared.

TABLE 1

| | Degree of grafting of SO₄²⁻ |
|---|---|
| Reference | groups |
| P0 | 0% |
| P1 | 1% |
| P2 | 4% |
| P3 | 8% |

### Preparation of Electrolytic Solutions Containing Particles

The electrolytic solutions were prepared from PEGDME (molar mass: 500 g/mol⁻¹) and LiClO₄ (sold by Aldrich) compounds. These compounds were vacuum dried for three days at 60° C. and 120° C. respectively, before being used. Solutions containing 10⁻³ to 3 mol/kg of lithium salt with respect to the polymer were prepared.

After vacuum drying for 3 days at 150° C., the particles prepared as described above were introduced into the electrolytic solutions in a proportion equal to 10% by weight relative to the PEGDME.

The solutions were then stirred for one week, in order to ensure that the particles were properly dispersed.

### Characterization of the Electrolytic Solutions

The various electrolytic solutions prepared were characterized by ionic conductivity measurements and by DSC (differential scanning calorimetry).

The measurements were performed on four different electrolytic solutions, namely three electrolytic solutions containing particles P1 to P3 and one reference electrolytic solution (denoted in the figures by the letter A) not containing mineral particles.

Ionic Conductivity

The ionic conductivity was determined by the complex impedance method at temperatures varying from −20° C. to 70° C. The specimens were placed between stainless steel electrodes and then put into a thermostated bath. The impedance measurements were made on an apparatus of the Solartron-Schlumberger 1255 reference within a frequency range between 200 000 Hz and 1 Hz.

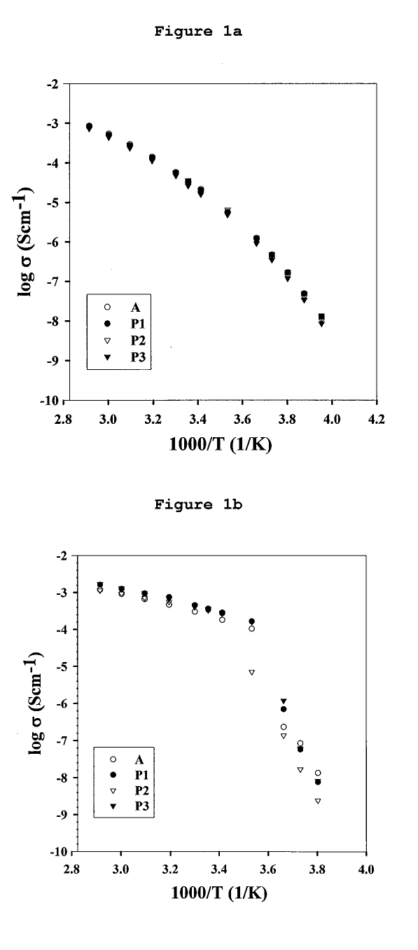

The results of these measurements are given in FIGS. 1a to 1c, which show the logarithm of the conductivity, expressed in siemens per centimeter (S·cm⁻¹), as a function of the inverse of the temperature (expressed in degrees kelvin) multiplied by a factor of 1000, for lithium salt concentrations equal to 3 mol per kg of polymer (FIG. 1a), 1 mol per kg of polymer (FIG. 1b) and 0.01 mol per kg of polymer (FIG. 1c).

It is apparent from these figures that the addition of mineral particles, whatever the degree of grafting of the acid groups, does not appreciably modify the conductivity of the electrolytic solutions, and consequently does not cause any degradation thereof.

DSC Measurements

The DSC measurements were carried out on an apparatus with the reference Perkin-Elmer Pyris 1. The specimens were firstly stabilized by slow cooling down to −120° C., before being heated at 20° C. per minute up to 150° C. The error in the glass transition temperature measurement (T_{g}) was estimated to be ±2° C.

These measurements provide information about the effect of the mineral fillers with regard to the movement of the polymer chains, by measuring the evolution in glass transition temperature.

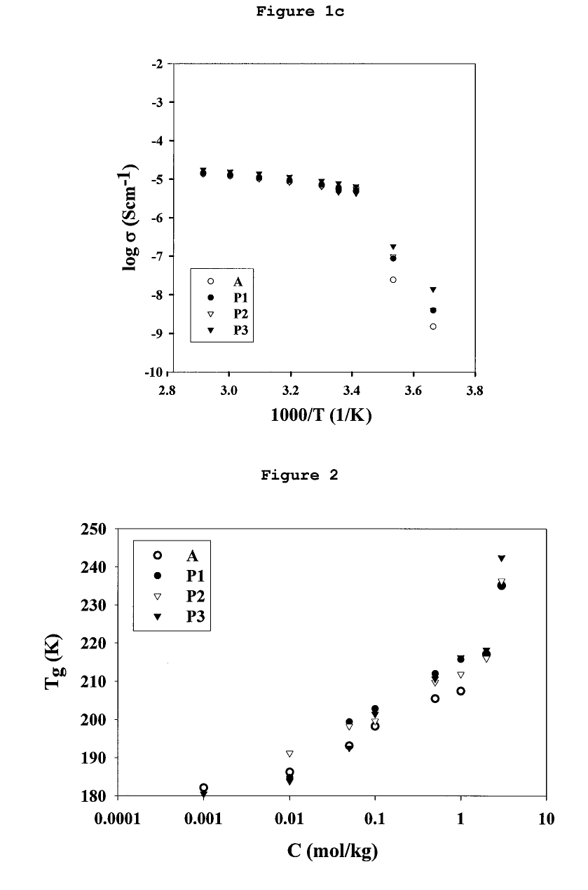

The results are presented in FIG. 2, which shows the glass transition temperature T_{g}, expressed in degrees kelvin, as a function of the lithium salt concentration C, expressed in mol/kg.

The results obtained confirm that the presence of mineral particles has no impact on the intrinsic properties of the electrolytic solution that contains them. The mineral particles therefore get no interaction with the salt or the polymer in solution liable to degrade the electrolytic solution.

### Application to a Lithium-Lithium Cell

Four electrochemical cells were prepared. The cells were assembled in a glove box under an argon atmosphere. Each cell was placed vertically so as to keep the lithium electrodes, in the form of disks, horizontal. For each cell, a first lithium electrode was placed on a stainless steel piston, which itself was placed in a glass cell. A circular polyethylene spacer was then added so as to define a constant distance between the two electrodes. The center of the spacer was filled with the electrolytic solution, and then a second lithium electrode and a second stainless steel piston were added. The cell was then sealed.

Table 2 below indicates the composition of the electrolytic solution introduced into each of the four cells, the lithium salt concentration being equal to 1 mol of salt per kg of polymer for all the electrolytic solutions.

TABLE 2

| Reference of the cell | Electrolytic solution |
|---|---|
| C_{ref} | PEGDME/LiClO₄ |
| C1 | PEGDME/LiClO₄ + particles P1 |
| C2 | PEGDME/LiClO₄ + particles P2 |
| C3 | PEGDME/LiClO₄ + particles P3 |

The change in interfacial resistance of the cells was monitored over a period of 20 days at ambient temperature, each day recording the impedance spectra using EQ version 4.55 software.

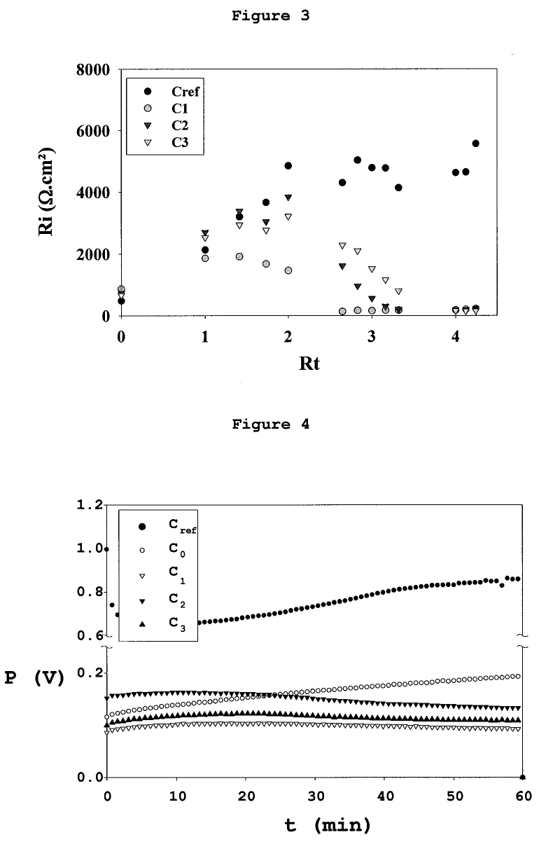

The results obtained for the four cells are shown in FIG. 3, in which the interfacial resistance Ri (in ohms·cm²) is plotted as a function of the square root of the time Rt, the time being expressed in days.

The figure shows that, for the cell C_{ref}, the interfacial resistance increases strongly for the first few days, before reaching a plateau. This phenomenon is attributed to the formation of a passivation layer created by the degradation of the electrolytic solution on the surface of the lithium electrode. The resistance values reached preclude the use of the lithium metal as a negative battery electrode.

In contrast, as regards the other three cells C1 to C3, FIG. 3 shows that the value of the interfacial resistance increases over the first few days, but then decreases substantially, down to a value below the initial value. This phenomenon results from the sedimentation of the particles and the formation of a film on the surface of the lithium.

The stability of the electrolytic solution/lithium electrode interface was studied by galvanostatic polarization with a current density j=0.3 mA/cm². FIG. 4 shows the curves obtained for the cell C_{ref}, for the cells C1 to C3 and for a cell C0 containing an electrolytic solution into which the reference mineral particles P0 were introduced, that is to say not grafted by acid functional groups. In FIG. 4, the potential P in volts is plotted as a function of the time t in minutes.

It follows from the analysis of these curves that the potential induced by the polarization in the case of the cell C_{ref} is greater by a factor of 7 than the cells in which the electrolytic solution contains mineral particles. This parameter, directly proportional to the interfacial resistance, confirms the results given in FIG. 3. Furthermore, the smooth appearance of the curves obtained in the case of the cells C0 to C3 very clearly indicates the stability of the mineral particles deposited on the surface of the lithium electrode.

1. A method of modifying the interfacial resistance of a lithium metal electrode immersed in an electrolytic solution, comprising depositing a film of metal oxide particles on the surface of said electrode.

2. The method as claimed in claim 1, wherein the particles are deposited by dispersing them in the electrolytic solution followed by their sedimentation on the surface of the electrode.

3. The method as claimed in claim 1 wherein the metal oxide is selected from the group consisting of Al₂O₃, SiO₂, TiO₂, ZrO₂, BaTiO₃, MgO and LiAlO₂.

4. The method as claimed in claim 1, wherein prior to the deposition, said metal oxide particles are modified by grafting onto their surface groups having an acidic character.

5. The method as claimed in claim 4, wherein the metal oxide particles are Al₂O₃ particles modified by SO₄²⁻ groups.

6. The method as claimed in claim 4, wherein the metal oxide particles are modified by bringing the particles into contact with an aqueous solution containing the acid groups to be grafted, followed by drying and calcination of the particles.

7. The method as claimed in claim 1, wherein the electrolytic solution consists of a lithium salt and a solvent or a mixture of solvents.

8. The method as claimed in claim 7, wherein the solvent(s) is (are) of the polar aprotic type.

9. The method as claimed in claim 7, wherein the solvent consists of polyethylene glycol dimethyl ether (PEGDME) and the lithium salt is lithium perchlorate (LiClO₄).

10. The method as claimed in claim 1, wherein the film of metal oxide particles is deposited on the surface of said electrode during the operation of an electrochemical cell comprising an anode, formed by said electrode, and a cathode, said anode and said cathode being separated by an electrolytic solution.

11. The method as claimed in claim 10, wherein said electrochemical cell is used as a battery, the deposition of the metal oxide particles taking place before the battery is put into operation.

12. The method as claimed in claim 10, wherein said electrochemical cell is used as a battery, the deposition of the metal oxide particles taking place during the first operating cycles of the battery.

13. A lithium metal electrode for a battery, the surface of said electrode being covered with a film of metal oxide particles,
wherein the particles are Al₂O₃ particles modified on the surface by SO₄²⁻ groups.

14. A battery of the lithium metal type, comprising an anode and a cathode that are separated by an electrolytic solution, wherein:
the anode and the cathode are in the form of parallel sheets, the cathode being above the anode; and
the anode consists of a lithium sheet, the surface of which facing the electrolytic solution is covered with a film of metal oxide particles.

15. The battery as claimed in claim 14, wherein the sheets constituting the anode and the cathode are horizontal or approximately horizontal.

16. The battery as claimed in claim 14, wherein the metal oxide is selected from the group consisting of Al₂O₃, SiO₂, TiO₂, ZrO₂, BaTiO₃, MgO and LiAlO₂.

17. The battery as claimed in claim 16, wherein the metal oxide particles are Al₂O₃ particles modified on the surface by SO₄²⁻ groups.

18. The battery as claimed in claim 14, wherein the electrolytic solution consists of a lithium salt and a solvent or a mixture of polar aprotic solvents.
